(19) United States
(12) Patent Application Publication
(10) Pub. No.: US 2010/0264707 A1
(43) Pub. Date: Oct. 21, 2010

(54) BELT BUCKLE AND BELT ASSEMBLY

(75) Inventors: Terence Tang, Tsing Yi (HK); Peter Miller, Phoenix, AZ (US); Michael A. Wiseman, Elkhart, IN (US)

Correspondence Address: MERCHANT & GOULD PC, P.O. BOX 2903, MINNEAPOLIS, MN, 55402-0903, US

(73) Assignee: Holmbergs Childsafety AB, Anderstorp (SE)

(21) Appl. No.: 12/764,784

(22) Filed: Apr. 21, 2010

Related U.S. Application Data
(60) Provisional application No. 61/171,274, filed on Apr. 21, 2009.

(51) Int. Cl. B60N 2/26; A44B 11/25; A44B 11/26; B60R 22/12

(52) U.S. Cl. 297/250.1; 24/593.1; 297/468

(57) ABSTRACT

A belt buckle comprising a housing and a pair of tongues. The said housing has a mid plane through said housing, wherein each tongue has a web attachment portion and a stem configured to be inserted into and releasably locked in said housing. Further, each stem has a main portion with an elongate cross-section which, when said stem is inserted into said housing, extends in a first direction forming an angle with respect to said mid plane. The angle is in a range of 70-110 degrees.

### CROSS-REFERENCE TO RELATED APPLICATIONS

A claim of priority to U.S. Application Ser. No. 61/171,274 filed on Apr. 21, 2009 is made to the extent appropriate.

### TECHNICAL FIELD

The present invention generally relates to devices for securing belts to each other, and more specifically it concerns such devices for securing a child in a child seat.

### BACKGROUND

During transportation of a child, the child is normally placed in a child seat, or similar, attachable to a car, baby carrier, stroller or the like. Once the child has been positioned in the seat, he/she may be secured using one or more belts attached to the seat. In order to standardize the way such belts are connected to each other they may be provided with a suitable buckle. Most buckles of this type comprise two tongues and one main body into which the tongues may be inserted and releasably locked.

In different countries there are different regulations to which such buckles must conform. For example, in many European countries the two locking tongues must be designed in such a way that they have to be interlocked before they can be inserted into the main body for interlocking engagement with the main body of the buckle. However, in the USA the tongues can be either separately latchable to the main body or interlocked with each other before latching to the main body.

WO 2005/000063 discloses a buckle having two separately latchable tongues and a main body. The tongues consist of a flat metal main body plate wholly covered by a plastic or rubber housing or coating. Each tongue has a web attachment portion for attachment to a belt, and a stem arranged to be received and locked in the body. At the very end of the stem, the flat metal main body plate has been bent to form a catch tooth for locking the tongue element in the body.

A disadvantage with this prior-art buckle is that dirt and other foreign objects tend to enter the tongue openings of the main body, which might cause malfunction of the buckle.

Another disadvantage of the above described buckle is that its tongues may bend, or even brake, upon impact on the buckle in a direction towards the body of a child secured using the buckle. A broken buckle forced against the body of a child may cause injuries.

Hence, an improved buckle mitigating the above described deficiencies would be beneficial.

### SUMMARY

An improved belt buckle and belt assembly are described. The belt buckle comprises a housing, and a pair of tongues. Said buckle has a mid plane through said housing. Each tongue has a web attachment portion and a stem configured to be inserted into and releasably locked in the housing. Each stem has a main portion with an elongate cross-section which, when the stem is inserted into the housing, extends in a first direction. The first direction forms an angle with respect to said mid plane in a range of 70 to 110 degrees.

Such an improved buckle is resistant to any impact in most likely impact directions (being directions towards the chest region of a child being secured by the buckle) and therefore lowers the risk of injuries caused by broken or deformed buckle parts.

According to another aspect of the invention, the first direction forms a substantially perpendicular angle to the support surface of the housing. Such a design gives a high strength against forces acting on the buckle and reaction forces thus created in a normal direction to the support surface.

According to another aspect, the stem may further comprise a reinforcement portion extending from the web attachment portion at least partly along the stem. An advantage of such a design is that the stem gets increased rigidity and additional strength against impacts/loads in directions other than the first direction of the stem

The buckle may also be designed with a cross-section of the reinforcement portion extending from the main portion in a second direction at an angle to the first direction in a range of 70 to 110 degrees. Such a reinforcement portion provides additional rigidity of the stem whilst keeping down the overall dimensions of the stem.

The second direction may, according to an aspect, form a substantially perpendicular angle to the first direction. An advantage of this design is that a high bending resistance of the main portion of the stem is achieved using a minimum of material.

According to another aspect, the tongues are independently latchable in the housing. This brings a further advantage that the tongues are easy to handle during insertion into the housing.

According to yet another aspect, the stem has a goods thickness in a range of 1 to 4 mm. This brings the advantage that the size of openings in the housing for receiving the tongues are kept to a minimum, wherein the risk of dirt and foreign objects entering the buckle is reduced when the tongues are not inserted into the housing.

According to another aspect, the belt buckle comprises a housing and a pair of tongues. The housing has a mid plane. Further, each tongue has a web attachment portion and a stem configured to be inserted into and releasably locked in said housing. Also, each stem has a substantially L-shaped cross-section.

Such a buckle provides for improved strength and is less prone to breaking.

The inventive belt assembly comprises two upper webs, a lower web and a belt buckle according to any of the above mentioned aspects of a buckle. Such a belt assembly brings the advantage that an end customer for such an assembly easily can incorporate a buckle according to an aspect of the invention into any product of his/hers choice, whilst ensuring intended quality of the belts, or webs, and thus ensuring functionality between the belts, or webs, and the buckle.

According to yet another aspect, the belt buckle comprises a housing, a locking mechanism and first and second tongues. The housing has a web attachment portion, a central area, and a stem opening. The locking mechanism is provided within the housing central area. Further, each tongue comprises a web attachment portion and a stem extending from the web attachment portion. Also, each stem is configured to be inserted into the stem opening and engage the locking mechanism. Each stem comprises a main portion having a first elongate cross-sectional direction, and a reinforcement portion having a second elongate cross sectional direction. The first elongate cross-sectional direction is different from the second elongate cross-sectional direction.

Further, the main portion and the reinforcement portion extend a sufficient length so that both the main portion and the reinforcement portion extend from the web attachment portion and engage the locking mechanism when the tongue is in locking engagement with the locking mechanism.

Such a buckle resists both long term and short term stress well.

Further features of the invention and its aspects are set forth in the appended claims.

### BRIEF DESCRIPTION OF DRAWINGS

In the following, embodiments of the invention will be described with reference to non-limiting examples shown in the accompanying drawings, in which:

FIG. 1 is a perspective view showing a buckle connecting three webs,

FIG. 2 is a top view of a buckle according to an embodiment of the invention,

FIG. 3 is a perspective view of the buckle shown in FIG. 2,

FIG. 4 is a top view of the buckle of FIGS. 2-3, showing two tongues to be inserted in a housing of the buckle,

FIG. 5 is an exploded perspective view of the buckle shown in FIGS. 2-4,

FIG. 6 is an exploded side view of the buckle of FIGS. 2-5,

FIG. 7 is a front view of a tongue of a buckle according to FIGS. 2-6,

FIG. 8 is a view of the housing of a buckle according to FIGS. 2-7,

FIG. 9 is a front view of a tongue of a buckle according to another embodiment of the invention,

FIG. 10 is a front view of a tongue of a buckle according to yet another embodiment of the invention, and

FIG. 11 is an exploded perspective view of a buckle according to an alternative embodiment of the invention.

### DETAILED DESCRIPTION

A belt buckle 1 according to an embodiment of the invention is primarily intended for securing a child C to a child seat CS, or similar, for use in a vehicle, such as a car, baby carrier, stroller or the like (not shown).

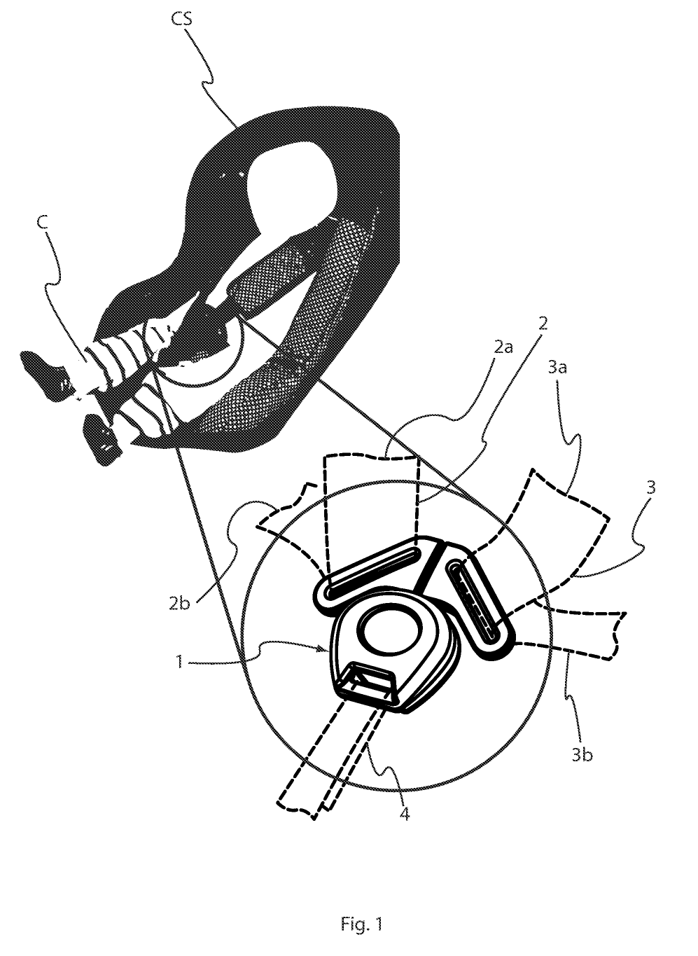

FIG. 1 shows the child C secured to the child seat CS using two upper webs 2, 3 interconnected to a lower web 4 using the buckle 1. The buckle 1 is positioned in front of a stomach region of the child C.

As shown in the enlarged view of FIG. 1, each upper web 2, 3 has an upper end 2a, 3a and a lower end 2b, 3b respectively. Either end 2a, 2b, 3a, 3b may be fixedly or length adjustably attached to the child seat CS, or to some other part or web attached to the child seat CS. The belt assembly can include web adjusters well known in the art (not shown).

The buckle 1 shown in FIG. 2 has a main body, or housing, 5 and a left and a right tongue 6, 7 shown in a fully inserted position in which the tongues 6, 7 are locked to the housing 5 using a locking mechanism integrated into the housing 5. The configuration shown can be referred to as a locking engagement when the left and right tongues 6, 7 are fully inserted and locked. Belts or webs 2, 3 (schematically shown) are fastened to attachment portions of the tongues 6, 7 in a manner known in the art. With respect to FIG. 3, the housing 5 has a central opening 9 through which a release button 10 is accessible. The release button 10 controls the locking action of the locking mechanism so that when the release button 10 is pushed into the housing 5, it releases the locking mechanism, whereafter the tongues 6, 7 are free to be pulled out of the housing 5. Further, the housing 5 has a web attachment portion 11 with an attachment opening 12 through which the lower web 4 passes for securing the housing 5 to the child seat CS (see FIG. 1).

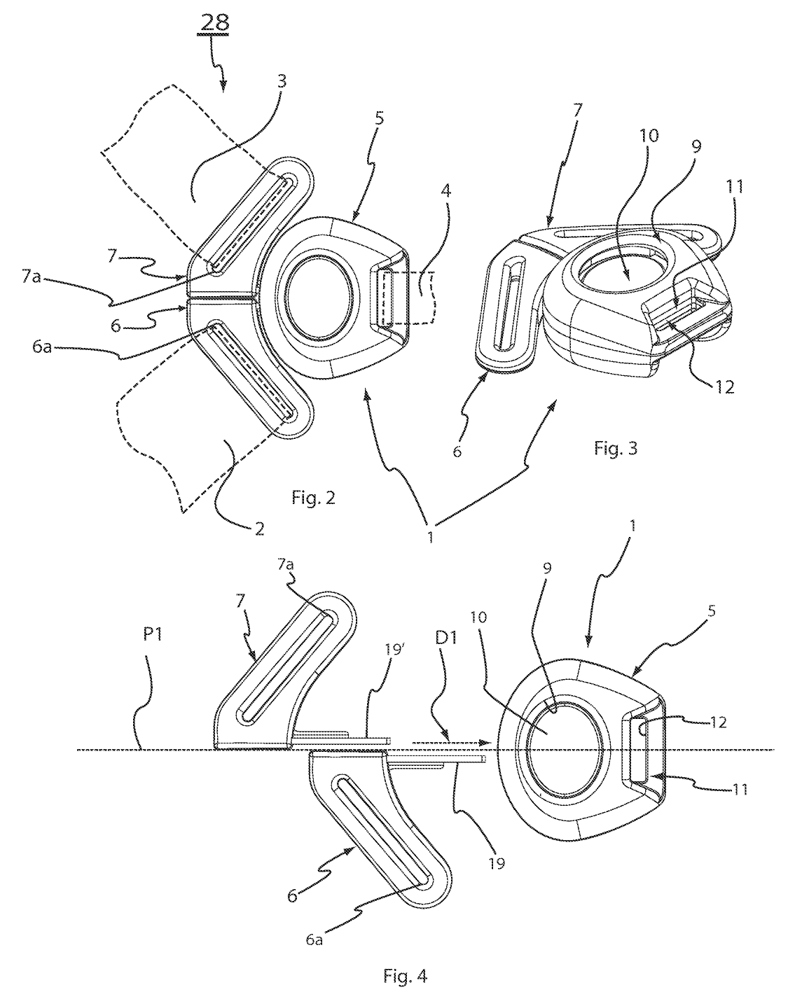

As shown in FIG. 4, the tongues 6, 7 are symmetric relatively a first plane P1 which coincides with an insertion direction D1 into the housing 5. Since the tongues 6, 7 are symmetric only one of them will be thoroughly described below. Here, it should be understood that the tongues 6, 7 have no interfering/interlocking features and thus are free to move into and out of the housing 5 independently of each other. In other words, the tongues 6, 7 are independently latchable to the housing 5.

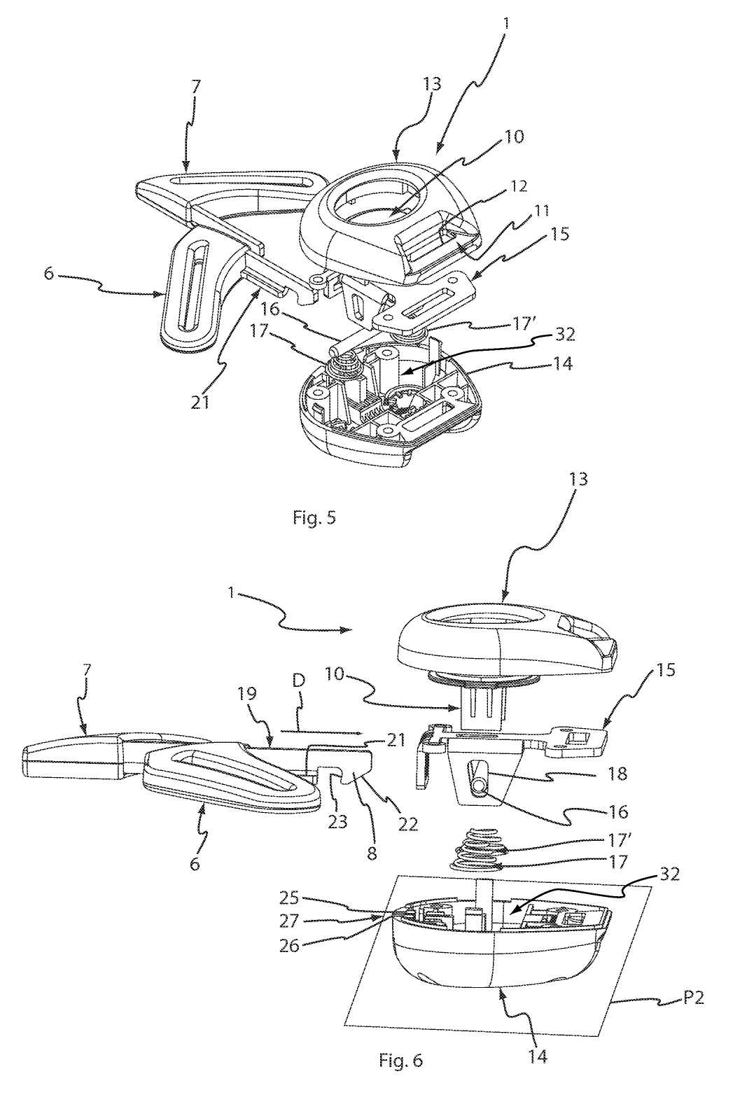

FIGS. 5 and 6 show that the housing 5 has an upper cover 13, in which the central opening 9 is provided, and a lower cover 14, to which a metal frame 15 is attachable using screws (not shown). The upper and lower covers 13, 14 put together serve as a housing for the locking mechanism and the release button 10. In addition to the frame 15, the locking mechanism comprises a locking member in the shape of a locking pin 16 and two locking pin biasing members 17, 17′, preferably coil springs. The frame 15 is provided with two guiding slots 18 for guiding the ends of the locking pin 16. In addition, the locking mechanism fits within the central area 32 formed by the upper cover 13 and the lower cover 14.

As shown in FIG. 6, the coil springs 17, 17′ are positioned in the central area 32 between the lower cover 14 and the locking pin 16. When the frame 15 is secured to the lower cover 14, the coil springs 17, 17′ are squeezed between the locking pin 16 and the lower cover 14 so that the coil springs 17, 17′ bias the locking pin 16 towards a locking position.

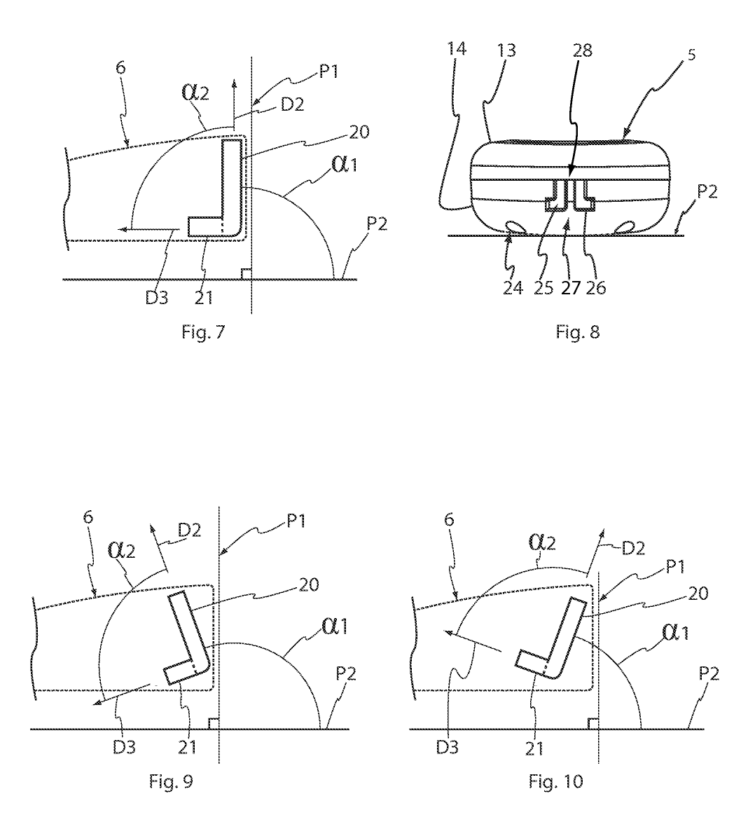

FIGS. 5-7 illustrate that the left tongue 6 has a stem 19 with a main portion 20 and a reinforcement portion 21 (in FIG. 7 distinguished from each other by a dotted line across the stem 19 defining the border between the portions). The stem 19 is a piece of bent sheet metal with a thickness in a range of 1 to 4 mm, preferably 2.5 mm. The end of the stem 19 is provided with a catch tooth 8 having a sloped guide surface 22 and a stop surface 23 for interaction with the locking pin 16 of the locking mechanism. The guide surface 22 makes it possible to insert the tongue 6 into the housing 5 without having to first depress the release button 10 to move the locking pin 16 towards its unlocking position. During insertion of the stem 19 of the tongue 6 into the housing 5, the locking pin 16 slides along the guide surface 22 until it is finally pushed by the coil springs 17, 17′ to the locking position in which the locking pin 16 acts on the stop surface 23 to keep the tongue 6 from being pulled out of the housing 5.

When the release button 10 is depressed, it forces the locking pin 16 to move within the guiding slots 18, against the force of the coil springs 17, 17′, to an unlocking position in which the locking pin 16 no longer acts to block the stop surface 23.

As indicated by a dashed line in FIG. 8, the housing 5 has a support surface 24. When the buckle 1 is in use and positioned in front of the stomach region of the child C (see FIG. 1), the support surface 24 rests against the stomach region and thereby supports the housing 5 during impacts from directions from in front of the child C, towards the child C. The support surface 24 is slightly rounded and has no sharp features extending from the surface 24 which might injure a child secured by the buckle 1. Further, the support surface 24 may be approximated by a planar surface defining a second plane P2 being perpendicular to the first plane P1 and which is called support surface P2 in the following.

As shown in FIG. 7, the stem 19 has a substantially L-shaped cross-section in which the main portion 20 defines the longest leg of the L-shape and the reinforcement portion 21 defines the shortest leg of the L-shape.

Although an L-shape is shown in the figures, it should be understood that the reinforcement portion 21 and the main portion 20 could also be arranged in other ways relatively each other, such as in a T-shape, in which the main portion 20 defines the longest leg of the T-shape and the reinforcement portion 21 defines one or both of the two shorter legs of the T-shape.

The cross-section of the main portion 20 of the stem 19 is elongate and extends in a support direction, or first direction, D2 forming a first angle α1 to the support surface P2 in a range of 70 to 110 degrees, preferably a perpendicular angle, as shown in FIG. 7.

This arrangement of the main portion 20 provides for high strength of the stem 19 against impacts in directions from in front of the child C towards the child C. Expressed in an alternative way, said first angle al of 70-110 degrees is formed with respect to a mid plane through the housing 5.

As shown in FIG. 8, the housing 5 includes a stem opening 27 for receiving the tongues 6, 7 (for example the first tongue and the second tongue). The stem opening 27, as shown in FIG. 8, includes a left tongue opening 25 and a right tongue opening 26, and are shaped and sized to closely, but not tightly, follow the cross-section of the left and right tongues 6, 7 respectively, thereby minimizing the risk of foreign objects or dust entering the tongue entry openings 25, 26 when the tongues 6, 7 are not inserted into the housing 5. In order to minimize the size of the tongue openings 25, 26, the goods thickness of the stem 19, and thereby the width of its cross-section, may be kept low.

The reinforcement portion 21 of the stem 19 provides for increased rigidity and additional strength against impacts/loads in directions other than the support direction D2 of the stem 19 by having a cross-section extending in a reinforcement direction D3 at a second angle α2 to the support direction D2. The second angle α2 is in a range of 70 to 110 degrees, preferably perpendicular, as shown in FIG. 7.

When the tongue 6 is locked inside the housing 5, the highest momentum and stress will most likely occur at the base of the stem 19, close to the web attachment portion 6a, hence, the reinforcement portion 21 extends from the web attachment portion 6a at least partly along the stem 19 to provide increased rigidity where best needed.

FIGS. 9 and 10 show two examples of alternative embodiments of the invention, which as compared to the embodiment shown in FIG. 7 has a differently designed stem having support directions D2 forming angles α1 with respect to the support surface P2 of the housing of 110 and 70 degrees respectively.

The main portion 20 and the reinforcement portion 21 can be characterized as having a first elongate cross-sectional direction and a second elongate cross-sectional direction, respectively. The first elongate cross-sectional direction refers to the direction extending in the long dimension of the cross-section. In FIG. 7, this corresponds to direction D2. The second elongate cross-sectional direction refers to the direction extending in the long dimension of the cross-section. In FIG. 7, this corresponds to direction D3.

It should be understood that the belt buckle 1 comprises the housing 5 and the two tongues 6, 7. According to an embodiment of the invention, as shown in FIGS. 1 and 5, a belt assembly 28 may be produced by providing the buckle 1 with two upper belts, or webs, 2, 3 and a lower belt, or web, 4, thus enabling interconnection of the belts, or webs, 2, 3, 4 with the help of the buckle 1.

Such a belt assembly 28 brings the advantage that an end customer for such an assembly 28 easily can incorporate a buckle 1 according to an embodiment of the invention into any product of his/hers choice, whilst ensuring intended quality of the belts, or webs, and thus ensuring functionality between the belts, or webs, 2, 3, 4 and the buckle 1.

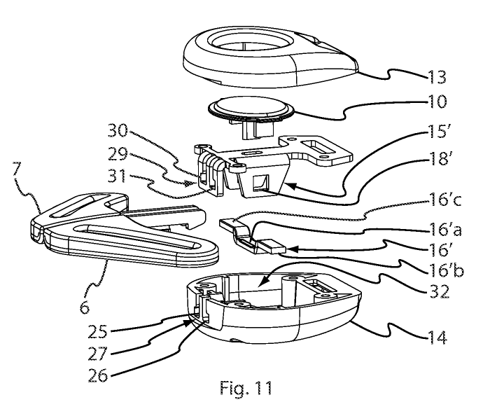

According to an embodiment, as shown in FIG. 11, the locking mechanism comprises a modified frame 15′ and an alternative locking member in the shape of a yoke 16′ having a central portion 16′a and two flanges 16′a, 16′b which are offset with respect to said central portion 16′a.

The locking mechanism according to this embodiment provides improved strength thanks to the design of the yoke shaped locking member 16′ engaging with the frame 15′.

The locking mechanism is additionally shown having a locking mechanism opening 29 for receipt of the left and right tongues 6, 7. The locking mechanism opening 29 is shown in FIG. 11 as including a first locking mechanism opening 30 and a second locking mechanism opening 31. For example, the left tongue 6 can be received within the first locking mechanism opening 30, and the right tongue 7 can be received within the second locking mechanism opening 31, when provided in locking engagement. Furthermore, when provided in locking engagement, both the main portion 20 and the reinforcement portion 21 can extend within the first and second locking mechanism openings 30 and 31 in order to enhance strength.

It should be mentioned that the invention is not limited to the embodiments described herein, and several modifications are feasible within the scope of the invention as defined in the appended claims. For instance, although shown in the figures as substantially perpendicular, the reinforcement direction D3, in which the cross-section of the reinforcement portion 21 may extend from the main portion, may have an angle α2 to the support direction D2 in a range of 70 to 110 degrees for giving optimum reinforcement depending on the intended use and predicted load directions of the buckle.

1. A belt buckle comprising a housing and a pair of tongues, wherein said housing has a mid plane through said housing, wherein each tongue has a web attachment portion and a stem configured to be inserted into and releasably locked in said housing, and wherein each stem has a main portion with an elongate cross-section which, when said stem is inserted into said housing, extends in a first direction forming an angle with respect to said mid plane, said angle being in a range of 70-110 degrees.

2. A belt buckle according to claim 1, wherein said first direction forms a substantially perpendicular angle with respect to said mid plane of said housing.

3. A belt buckle according to claim 1, wherein each stem further comprises a reinforcement portion having an elongate cross section extending away from said web attachment portion, and said reinforcement portion extending at least partly along said stem.

4. A belt buckle according to claim 3, wherein a cross-section of said reinforcement portion extends from said main portion in a second direction at an angle to said first direction in a range of 70 to 110 degrees.

5. A belt buckle according to claim 4, wherein said reinforcement direction forms a substantially perpendicular angle with respect to said support direction.

6. A belt buckle according to claim 1, wherein said tongues are independently latchable in said housing.

7. A belt buckle according to claim 1, wherein each stem has a goods thickness in a range of 1 to 4 mm.

8. A belt buckle comprising a housing and a pair of tongues, wherein said housing has a mid plane, wherein each tongue has a web attachment portion and a stem configured to be inserted into and releasably locked in said housing, and wherein each stem has a substantially L-shaped cross-section.

9. A belt buckle according to claim 8, wherein said stem is a piece of sheet metal with a thickness in a range of 1 to 4 mm.

10. A belt buckle according to claim 9, wherein said thickness is 2.5 mm.

11. A belt buckle according to claim 8, wherein a main portion of said stem defines the longest leg of said L-shape and a reinforcement portion of said stem defines the shortest leg of said L-shape, and wherein said main portion of said stem, when said stem is inserted into said housing, extends in a first direction forming an angle with respect to a mid plane through said housing, said angle being in a range of 70-110 degrees.

12. A belt buckle according to claim 11, wherein said angle is substantially perpendicular.

13. A belt buckle according to claim 1, wherein said locking mechanism comprises a locking member, preferably a straight locking pin or a yoke shaped part.

14. A belt assembly comprising two upper webs and a lower web, wherein said belt assembly comprises a belt buckle as claimed in claim 1.

15. A belt buckle comprising:
(a) a housing having a web attachment portion, a central area, and a stem opening;
(b) a locking mechanism provided within the housing central area; and
(c) first and second tongues, wherein each tongue comprises a web attachment portion and a stem extending from the web attachment portion, wherein each stem is configured to be inserted into the stem opening and engage the locking mechanism, each stem comprises a main portion having a first elongate cross-sectional direction, and a reinforcement portion having a second elongate cross sectional direction, wherein the first elongate cross-sectional direction is different from the second elongate cross-sectional direction, and wherein the main portion and the reinforcement portion extend a sufficient length so that both the main portion and the reinforcement portion extend from the web attachment portion and engage the locking mechanism when the tongue is in locking engagement with the locking mechanism.

16. A belt buckle according to claim 15, wherein said locking mechanism comprises a locking member having two opposite ends, and a frame having two opposite apertures for movably receiving said opposite ends of said locking member, said locking member being configured to engage said tongues in a locked position within said housing.

17. A belt buckle according to claim 16, wherein said locking member comprises a straight locking pin.

18. A belt buckle according to claim 16, wherein said locking member comprises a yoke having a central portion and two flanges which are offset with respect to said central portion.

19. A belt buckle according to claim 15, wherein said stem opening comprises a first and a second stem opening.

20. A belt buckle according to claim 15, wherein said first elongate cross-sectional direction and said second elongate cross sectional direction extend at an angle to each other in a range of 70 to 110 degrees.

21. A belt buckle according to claim 15, wherein said first elongate cross-sectional direction and said second elongate cross sectional direction extend at an angle to each other of about 90 degrees.

22. A belt buckle according to claim 15, wherein said tongues are independently latchable to said locking mechanism.

23. A belt buckle according to claim 15, wherein each stem has a goods thickness in a range of 1 to 4 mm.

24. A belt buckle according to claim 19, wherein said first stem opening has a shape constructed to closely follow the shape of said first tongue stem, and said second stem opening has a shape constructed to closely follow the shape of said second tongue stem.

25. A belt buckle according to claim 19, wherein the shape of said first stem opening has a first elongate area and a second elongate area, and said first and said second elongate areas extend in different directions, and wherein the shape of said second stem opening has a first elongate area and a second elongate area, and said first and said second elongate areas extend in different directions.

26. A belt buckle according to claim 15, wherein said locking mechanism comprises a first opening for receiving said first tongue, and a second opening for receiving said second tongue, and a web attachment portion.

27. A belt buckle according to claim 15, wherein said housing includes a release button for controlling said locking mechanism.

28. A belt buckle according to claim 15, wherein said main portion and said reinforcement portion are provided as a result of bending a stem forming material.

29. A belt assembly comprising two upper webs and a lower web, wherein said belt assembly comprises a belt buckle as claimed in claim 15.

30. A child seat comprising:
(a) a seat sized for holding a child and including a first upper web, a second upper web, and a lower web; and
(b) a belt buckle comprising:
(i) a housing having a web attachment portion attached to said lower web, a central area, and a stem opening;
(ii) a locking mechanism provided within said housing central area; and
(iii) first and second tongues, wherein each tongue comprises a web attachment portion attached to one of the upper webs and a stem extending from the web attachment portion, wherein each stem is configured to be inserted into the stem opening and engage the locking mechanism, each stem comprises a main portion having a first elongate cross-sectional direction, and a reinforcement portion having a second elongate cross sectional direction, wherein in the first elongate cross-sectional direction is different from the second elongate cross-sectional direction, and wherein the main portion and the reinforcement portion extend a sufficient length so that both the main portion and the reinforcement portion extend from the web attachment portion and engage the locking mechanism when the tongue is in locking engagement with the locking mechanism.
